(19) United States
(12) Patent Application Publication
(10) Pub. No.: US 2024/0373356 A1
(43) Pub. Date: Nov. 7, 2024

(54) SIGNAL MONITORING METHOD, SIGNAL MONITORING APPARATUS, AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/291,513

(22) PCT Filed: Jul. 29, 2021
(86) PCT No.: PCT/CN2021/109226

§ 371 Date: Jan. 23, 2024

(51) Int. Cl. H04W 52/02; H04W 68/02

(52) U.S. Cl. CPC H04W 52/0229; H04W 68/02

(57) ABSTRACT

A signal monitoring method is performed by a terminal, and includes: monitoring a first power-saving signal by starting a first receiver, and determining a monitoring behavior of a paging message based on a monitoring state of the first power-saving signal; and monitoring, based on the monitoring behavior, a signal related to the paging message by starting a second receiver.

### CROSS-REFERENCE TO RELATED APPLICATIONS

The present application is a U.S. National Stage of International Application No. PCT/CN2021/109226, filed on Jul. 29, 2021, the content of which is incorporated by reference herein in its entirety.

### TECHNICAL FIELD

The present disclosure relates to the field of wireless communication technology, and in particular to a signal monitoring method, a signal monitoring device, and a storage medium.

### BACKGROUND

With the development of communication technology, a wake-up indication message, also called a wake-up signal for paging message, is introduced prior to the monitoring of paging messages in order to achieve power-saving effects. The subsequent Physical Downlink Control Channel (PDCCH) is determined by the paging message wake-up signal. When the terminal detects a PDCCH or a defined wake-up indication message, it needs to start the main radio device of the terminal.

### SUMMARY

According to a first aspect of the present disclosure, there is provided a signal monitoring method, performed by a terminal, including: monitoring a first power-saving signal by starting a first receiver, and determining a monitoring behavior of a paging message based on a monitoring state of the first power-saving signal; and monitoring, based on the monitoring behavior, a signal related to the paging message by starting a second receiver.

According to a second aspect of the present disclosure, there is provided a signal monitoring method, performed by a network device, including sending a first power-saving signal which is monitored by a terminal starting a first receiver, where the first power-saving signal is configured for the terminal to determine a monitoring behavior of a paging message, and the monitoring behavior is configured for the terminal to perform monitoring of a signal related to the paging message.

According to a third aspect of the present disclosure, there is provided a signal monitoring device, performed by the terminal, including a determining module configured to monitor a first power-saving signal by starting a first receiver, and determine a monitoring behavior of a paging message based on a monitoring state of the first power-saving signal; and a monitoring module configured to monitor, based on the monitoring behavior, a signal related to the paging message by starting a second receiver.

According to a fourth aspect of the present disclosure, there is provided a signal monitoring device, performed by a network device, including a sending module configured to send a first power-saving signal which is monitored by a terminal starting a first receiver, where the first power-saving signal is configured for the terminal to determine a monitoring behavior of a paging message, and the monitoring behavior is configured for the terminal to perform monitoring of a signal related to the paging message.

According to a fifth aspect of the present disclosure, there is provided a signal monitoring device, including a processor; and a memory for storing processor executable instructions; where the processor is configured to perform the signal monitoring method according to the first aspect or any embodiment in the first aspect, or perform the signal monitoring method according to the second aspect or any embodiment in the second aspect.

According to a sixth aspect of the present disclosure, there is provided a non-transitory computer-readable storage medium that, when instructions in the storage medium are executed by a processor of a mobile terminal, enables the mobile terminal to perform the signal monitoring method according to the first aspect or any embodiment in the first aspect, or perform the signal monitoring method according to the second aspect or any embodiment in the second aspect.

It should be understood that the above general description and the later detailed description are only exemplary and explanatory and do not limit the present disclosure.

### BRIEF DESCRIPTION OF THE DRAWINGS

The accompanying drawings herein, which are incorporated into and form a part of the specification, illustrate embodiments consistent with the present disclosure and are used in conjunction with the specification to explain the principles of the present disclosure.

FIG. 1 is an architectural diagram of a communication system between a network device and a terminal according to an embodiment.

FIG. 2 is a schematic diagram of starting the main radio device based on AZP according to an embodiment.

FIG. 3 is a flowchart of a signal monitoring method according to an embodiment.

FIG. 4 is a flowchart of yet another signal monitoring method according to an embodiment.

FIG. 5 is a flowchart of yet another signal monitoring method according to an embodiment.

FIG. 6 is a flowchart of a time-domain location of a power-saving signal in a signal monitoring method according to an embodiment.

FIG. 7 is a flowchart of a signal monitoring method according to an embodiment.

FIG. 8 is a flowchart of a time-domain location of a power-saving signal in a signal monitoring method according to an embodiment.

FIG. 9 is a flowchart of a signal monitoring method according to an embodiment.

FIG. 10 is a flowchart of yet another signal monitoring method according to an embodiment.

FIG. 11 is a flowchart of yet another signal monitoring method according to an embodiment.

FIG. 12 is a flowchart of yet another signal monitoring method according to an embodiment.

FIG. 13 is a block diagram of a signal monitoring device according to an embodiment.

FIG. 14 is a block diagram of yet another signal monitoring device according to an embodiment.

FIG. 15 is a block diagram for a signal monitoring device according to an embodiment.

FIG. 16 is a block diagram for yet another signal monitoring device according to an embodiment.

### DETAILED DESCRIPTION

Embodiments will be described herein in detail, examples of which are represented in the accompanying drawings. When the following description relates to the accompanying drawings, the same numerals in the different accompanying drawings indicate the same or similar elements unless otherwise indicated. The embodiments described in the following embodiments do not represent all embodiments consistent with the present disclosure. Rather, they are only examples of devices and methods consistent with some aspects of the present disclosure as detailed in the appended claims.

FIG. 1 is an architectural diagram of a communication system between a network device and a terminal according to an embodiment. Communication methods provided by the present disclosure may be applied in the communication system architecture diagram shown in FIG. 1. As shown in FIG. 1, a network side device may send signaling based on the architecture shown in FIG. 1.

It is to be understood that the communication system between the network device and the terminal shown in FIG. 1 is for schematic illustration only, and other network devices may be included in the wireless communication system. For example, core network devices, wireless relay devices, and wireless backhaul devices, etc., which are not depicted in FIG. 1, may also be included. The embodiments of the present disclosure do not limit the number of network devices and the number of terminals included in the wireless communication system.

It is further to be understood that the wireless communication system of the embodiment of the present disclosure is a network providing a wireless communication function. The wireless communication system may employ different communication technologies, such as code division multiple access (CDMA), wideband code division multiple access (WCDMA), time division multiple access (TDMA), frequency division multiple access (FDMA), orthogonal frequency-division multiple access (OFDMA), single Carrier FDMA (SC-FDMA), and Carrier Sense Multiple Access with Collision Avoidance. Different networks can be categorized as 2G (generation) networks, 3G networks, 4G networks, or future evolutionary networks such as 5G networks, which can also be referred to as New Radio (NR) networks, based on their capacity, rate, latency, and other factors. For ease of description, wireless communication networks sometimes are referred to simply as networks in the present disclosure.

Further, the network device involved in the present disclosure may also be referred to as a wireless access network device. The wireless access network device may be a base station, an evolved node B (base station), a home base station, an access point (AP), a wireless relay node, a wireless return node, a transmission point (TP) or a transmission and reception point (TRP) etc. in a wireless fidelity (WIFI) system, but also may be a gNB in a NR system, or, alternatively, may be a component or part of a device that constitutes a base station, etc. The network device may also be an in-vehicle device when it is a communication system for Vehicle to Everything (V2X). It should be understood that the specific technology and the specific device form used for the network device are not limited in the embodiments of the present disclosure.

Further, a terminal involved in the present disclosure, which may also be referred to as a terminal device, User Equipment (UE), Mobile Station (MS), Mobile Terminal (MT), etc., is a device that provides voice and/or data connectivity to a user. For example, the terminal may be a handheld device, an in-vehicle device, etc., having a wireless connectivity. Currently, some examples of terminals are: a smart phone (Mobile Phone), a pocket personal computer (PPC), a palmtop computer, a personal digital assistant (PDA), a laptop computer, a tablet computer, a wearable device, or an in-vehicle device, among others. In addition, the terminal device may also be an in-vehicle device when it is a communication system for Vehicle to Everything (V2X). It should be understood that the specific technology and the specific device form used for the terminal are not limited in the embodiments of the present disclosure.

It should be understood that although the terms first, second, third, etc. may be employed in the embodiments of the present disclosure to describe various information, such information should not be limited to these terms. These terms are only used to distinguish the same type of information from one another. For example, without departing from the scope of embodiments of the present disclosure, first information may also be referred to as second information, and similarly, second information may be referred to as first information. Depending on the context, as used herein, the phrase “if” may be interpreted as “at . . . ” or “when . . . ” or “in response to determining”.

In the communication system, if the terminal is in a non-connected state, the terminal needs to be periodically woken up to monitor the paging PDCCH. If the PDCCH is detected, it needs to monitor the subsequent Physical Downlink Shared Channel (PDSCH) and determine the information within the PDSCH to determine whether access to the network is required or whether to update system information. If the terminal does not detect the PDCCH, the terminal continues to sleep to save power.

In the related art, wake-up messages (which can also be referred to as wake-up indication messages) are introduced in order to reduce the power consumption of the terminal when monitoring paging messages. That is, before the terminal blindly monitors the paging PDCCH, the terminal needs to monitor the wake-up message. If the terminal detects the wake-up message, it determines that a subsequent paging PDCCH exists, and the terminal continues to monitor the paging PDCCH. If the terminal does not detect the wake-up message, it skips the monitoring of the paging PDCCH.

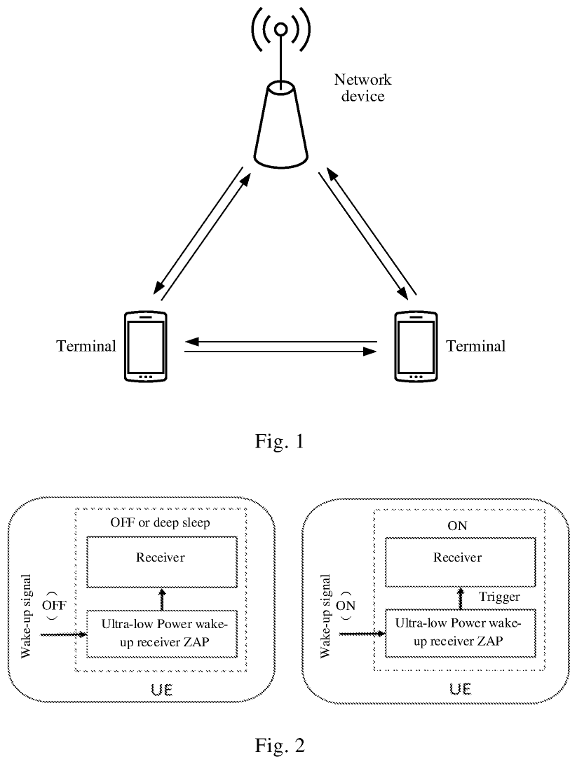

In the process of monitoring PDCCH or wake-up information at the terminal, it is necessary to start the main radio device, and the process of starting the main radio device is also relatively power-consuming. Therefore, an AZP receiver is introduced, i.e., an AZP receiver is additionally configured at the terminal. FIG. 2 is a schematic diagram of starting a main radio device based on an AZP according to an embodiment. As shown in FIG. 2, the AZP receiver is started when the terminal detects a PDCCH or a wake-up indication message. If the AZP receiver detects a wake-up signal, a receiver is triggered to be started for reception, and the receiver may be a main radio device. At this time, the receiver (main radio device) is turned on, otherwise, the terminal turns off the receiver or makes it continue to sleep to realize the effect of power-saving.

In related art, different wake-up signals are configured for different receivers. For example, a wake-up signal corresponding to the AZP receiver may be an AZP wake-up signal; and a wake-up signal corresponding to the main radio device may be a Wake Up Service (WUS) signal. If the wake-up signal is not introduced, it may also be based on monitoring a paging message, where the paging message may be paging Physical Downlink Control Channel (PDCCH) or paging Physical Downlink Shared Channel (PDSCH).

For different kinds of wake-up signals or paging messages, e.g., AZP wake-up signals, WUS signals, and paging messages, how the terminal monitors them is a technical problem that needs to be solved.

In view of this, the present disclosure provides a signal monitoring method that configures different paging monitoring methods for a terminal and configures a correspondence between wake-up signals and monitoring methods by a network device. When the terminal receives a wake-up signal, it can determine a monitoring method for paging monitoring, and monitor using the determined monitoring method. The network device may flexibly send different wake-up signals, and the terminal may also determine the monitoring method for monitoring the paging message based on the received wake-up signal, which improves the flexibility of monitoring the paging message as well as determines the monitoring method corresponding to the terminal itself, and thus may further reduce the power consumption.

In embodiments of the present disclosure, the wake-up signal may also be referred to as a power-saving signal. The following embodiments will illustrate the signal monitoring method of the present disclosure in conjunction with the accompanying drawings.

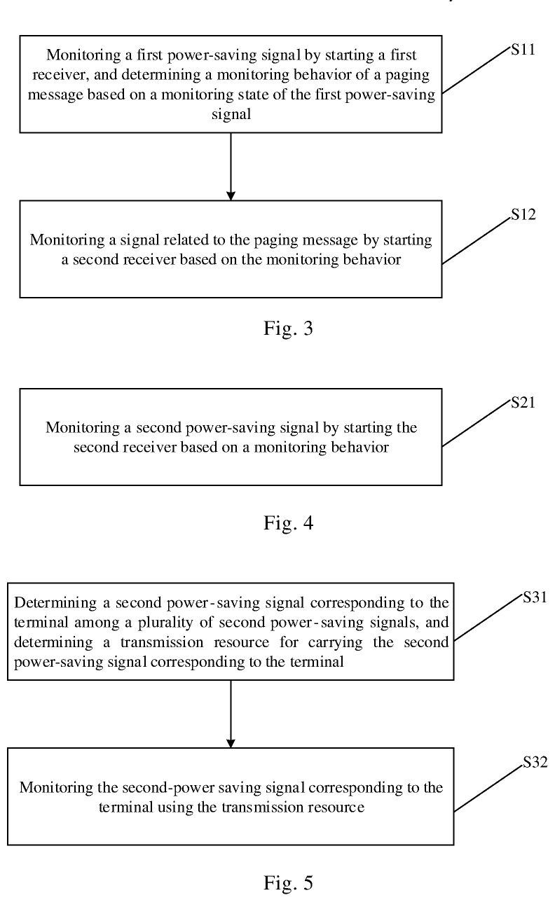

FIG. 3 is a flowchart of a signal monitoring method according to an embodiment. As shown in FIG. 3, the signal monitoring method is applied in a terminal and includes the following steps.

In step S11, monitoring a first power-saving signal by starting a first receiver, and determining a monitoring behavior of a paging message based on a monitoring state of the first power-saving signal.

In step S12, monitoring a signal related to the paging message by starting a second receiver based on the monitoring behavior.

In an embodiment of the present disclosure, the terminal starts the first receiver and monitors (or senses) the first power-saving signal based on the first receiver. The first receiver may be an AZP receiver and the first power-saving signal may be an AZP signal. Based on the monitoring state of the first power-saving signal, a monitoring behavior of the terminal monitoring the paging message is determined.

If the terminal detects the first power-saving signal based on the first receiver, the second receiver is started, and the second receiver is started to start monitoring the signal related to the paging message based on the determined monitoring behavior.

With the signal monitoring method provided by embodiments of the present disclosure, different paging monitoring manners are configured for the terminal, and the terminal can determine the monitoring behavior for monitoring the paging message based on the monitoring status of the received first power-saving signal. Thereby, the flexibility of monitoring paging messages is improved and the effect of reducing power consumption is achieved.

In the following embodiments of the present disclosure, a signal related to the paging message includes: a PDSCH for carrying the paging message and/or a PDCCH for scheduling the paging message.

In some embodiments of the present disclosure, the first power-saving signal may include one first power-saving signal, and the terminal, based on the monitoring behavior of the paging message, turns on the second receiver when the first power-saving signal is detected. FIG. 4 is a flowchart of a signal monitoring method according to an embodiment. The signal monitoring method is applied in a terminal, and the second receiver can be started by the steps as shown in FIG. 4 to monitor a signal related to a paging message based on the monitoring behavior.

In step S21, monitoring a second power-saving signal by starting the second receiver based on a monitoring behavior.

In an embodiment of the present disclosure, the terminal turns on the first receiver to monitor the first power-saving signal, and determines a monitoring state for monitoring the first power-saving signal.

If the monitoring state is to starting the second receiver to continue monitoring the second power-saving signal, the second receiver is started to monitor the second power-saving signal when the first power-saving signal is detected. The second receiver may be a main radio device. The power consumption of the first receiver is less than the power consumption of the second receiver. The second power-saving signal is configured to indicate whether the terminal detects the PDCCH corresponding to the paging message and/or the PDSCH corresponding to the paging message. For example, the second power-saving signal is one bit, a bit of 1 indicates that the terminal monitors the PDCCH corresponding to the paging message and/or the PDSCH corresponding to the paging message, and a bit of 0 indicates that the terminal does not monitor the PDCCH corresponding to the paging message and/or the PDSCH corresponding to the paging message.

In embodiments of the present disclosure, the number of second power-saving signals is a group, i.e., a plurality of second power-saving signals, and if the terminal detects the second power-saving signals at the corresponding transmission resources, it continues to start the second receiver to receive the paging message.

In embodiments of the present disclosure, a power consumption of the first receiver is less than a power consumption of the second receiver.

In the signal monitoring method provided in embodiments of the present disclosure, a first power-saving signal is monitored through a first receiver with almost zero power consumption first, which can save a power consumption of a terminal receiver. A second receiver is started to monitor a second power-saving signal on a corresponding transmission resource in the case that the first power-saving signal is detected, which can reduce the waste of resources.

In some embodiments of the present disclosure, the second power-saving signal includes a plurality of second power-saving signals. Each of the plurality of the second power-saving signals corresponds to a terminal from a different group. FIG. 5 is a flowchart of a signal monitoring method according to an embodiment. The signal monitoring method is applied in a terminal, and a second receiver may be started by steps as shown in FIG. 5 to monitor the second power-saving signals.

In step S31, determining a second power-saving signal corresponding to the terminal among a plurality of second power-saving signals, and determining a transmission resource for carrying the second power-saving signal corresponding to the terminal.

In step S32, monitoring the second power-saving signal corresponding to the terminal using the transmission resource.

In an embodiment of the present disclosure, the terminal determines, among the plurality of second power-saving signals, a second power-saving signal corresponding to the terminal, and monitors the second power-saving signal in the corresponding transmission resource. If the second power-saving signal is detected, the terminal determines that there exists a subsequent signal related to the paging message, and continues to monitor the subsequent signal related to the paging message. As described above, the signal related to the paging message may be a PDSCH carrying the paging message and/or a PDCCH scheduling the paging message. If the terminal does not detect the corresponding second power-saving signal using the transmission resource, the monitoring of the paging message is skipped.

In embodiments of the present disclosure, whether there is a subsequent signal related to the monitored paging message is determined based on the second power-saving signal, which can avoid power consumption associated with monitoring the paging message for a long period of time.

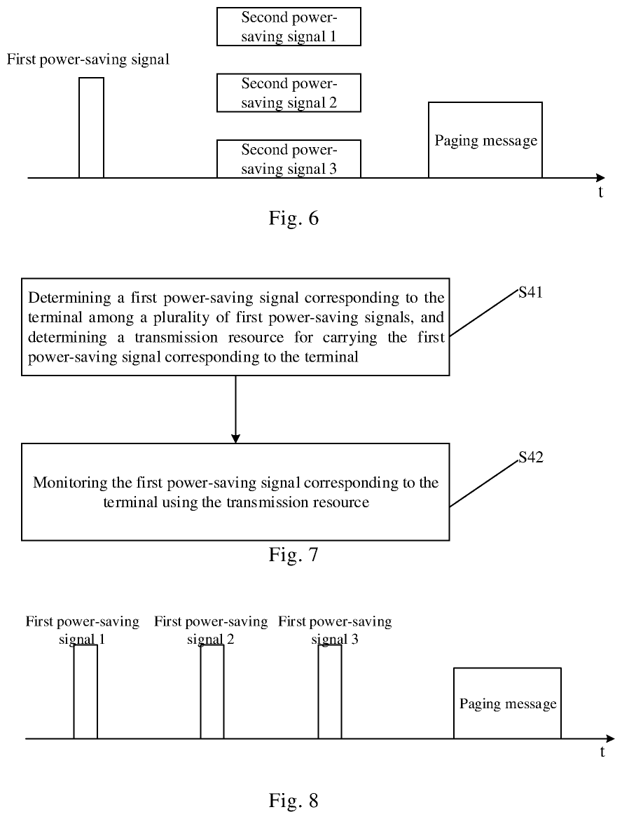

In some embodiments of the present disclosure, a time interval between the first power-saving signal and the second power-saving signal is greater than or equal to a first time threshold. The first time threshold is determined based on a communication capability of the terminal or a communication protocol. FIG. 6 is a flowchart of the time-domain location of a power-saving signal in a signal monitoring method according to an embodiment, applied in a terminal. As shown in FIG. 6, if the monitoring behavior of the terminal is to monitor a first power-saving signal based on a first receiver, then a second power-saving signal is monitored based on a second receiver when the first power-saving signal is detected, and a signal related to a paging message continues to be monitored if the second power-saving signal is detected. The first power-saving signal precedes the second power-saving signal, and the second power-saving signal precedes the signal related to the paging message. The second power-saving signal includes a plurality of second power-saving signals. For example, the second power-saving signal includes a second power-saving signal 1, a second power-saving signal 2, a second power-saving signal 3, and the like. In embodiments of the present disclosure, in FIG. 6, the first power-saving signal may be an AZP signal and the second power-saving signal may be a WUA signal. A time interval between the first power-saving signal and the second power-saving signal is greater than or equal to a first time threshold, which can avoid the terminal from losing the paging message to be monitored.

In some embodiments of the present disclosure, the first power-saving signal may include a plurality of first power-saving signals, each of the plurality of first power-saving signals corresponding to a terminal from a different group. The plurality of first power-saving signals is configured to instruct the terminal to monitor a PDCCH corresponding to the paging message and/or a PDSCH corresponding to the paging message. The terminal, based on the monitoring behavior of the paging message, starts to monitor a signal related to the paging message when the first power-saving signal is detected. FIG. 7 is a flowchart of a signal monitoring method according to an embodiment. The signal monitoring method is applied in a terminal, in which the first receiver may be started to monitor the signal related to the paging message based on the monitoring behavior using the steps as shown in FIG. 7.

In step S41, determining a first power-saving signal corresponding to the terminal among a plurality of first power-saving signals, and determining a transmission resource for carrying the first power-saving signal corresponding to the terminal.

In step S42, monitoring the first power-saving signal corresponding to the terminal using the transmission resource.

In an embodiment of the present disclosure, the terminal determines, among the plurality of first power-saving signals, a first power-saving signal corresponding to the terminal, and monitors the first power-saving signal in the corresponding transmission resource. If the first power-saving signal is detected, the terminal determines that there exists a subsequent signal related to the paging message, and continues to monitor the subsequent signal related to the paging message. As described above, the signal related to the paging message may be a PDSCH carrying the paging message and/or a PDCCH scheduling the paging message. If the terminal does not detect the corresponding first power-saving signal in the corresponding transmission resource, the monitoring of the paging message is skipped. By monitoring the first power-saving signal at the corresponding transmission resource, the terminal can avoid wasting resources and power consumption caused by the terminal monitoring other first power-saving signals.

In some embodiments of the present disclosure, a time interval between the first power-saving signal and the signal related to the paging message is greater than or equal to a second time threshold. The second time threshold is determined based on a communication protocol or a communication capability of the terminal. Configuring the time interval between the first power-saving signal and the signal related to the paging message to be greater than or equal to the second time threshold may avoid the terminal losing the signal related to the paging message due to switching receivers.

FIG. 8 is a flowchart of the time-domain location of a power-saving signal in a signal monitoring method according to an embodiment, which is applied in a terminal. As shown in FIG. 8, if the monitoring behavior of the terminal is to monitor a first power-saving signal based on a first receiver, and to monitor a signal related to the paging message based on a second receiver when the first power-saving signal is detected, then the first power-saving signal precedes the signal related to the paging message. The first power-saving signal includes a plurality of signals, for example, including a first power-saving signal 1, a first power-saving signal 2, a first power-saving signal 3, and the like. In embodiments of the present disclosure, the first power-saving signal in FIG. 8 may be an AZP signal.

Based on the same/similar idea, embodiments of the present disclosure also provide a signal monitoring method.

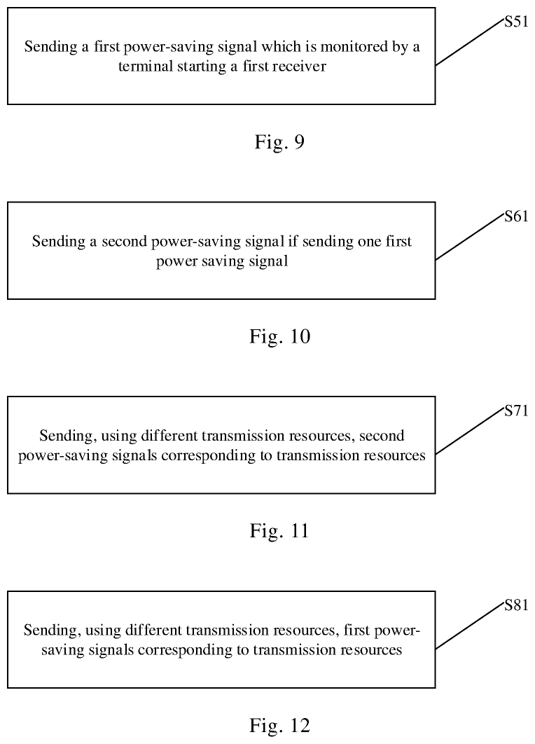

FIG. 9 is a flowchart of a signal monitoring method according to an embodiment. As shown in FIG. 9, the signal monitoring method is applied in a network device and includes the following steps.

In step S51, sending a first power-saving signal which is monitored by a terminal starting a first receiver.

In embodiments of the present disclosure, the network device may configure different monitoring behaviors for the terminal. The network side determines to send the first power-saving signal.

The terminal starts the first receiver and monitors (or senses) the first power-saving signal based on the first receiver. The first receiver may be an AZP receiver and the first power-saving signal may be an AZP signal. Based on the monitoring state of the first power-saving signal, a monitoring behavior of the terminal to monitor the paging message is determined.

If the terminal detects the first power-saving signal based on the first receiver, the second receiver is started, and the second receiver is started to start monitoring the signal related to the paging message based on the determined monitoring behavior.

With the signal monitoring method provided by embodiments of the present disclosure, different paging monitoring methods are configured for the terminal, and the terminal can determine the monitoring behavior for monitoring the paging message based on the monitoring state of the received first power-saving signal. Thereby, the flexibility of monitoring paging messages is improved and the effect of reducing power consumption is achieved.

In some embodiments of the present disclosure, the signal related to the paging message includes: a PDSCH for carrying the paging message and/or a PDCCH for scheduling the paging message.

In some embodiments of the present disclosure, the first power-saving signal may include one first power-saving signal, and the terminal, based on the monitoring behavior of the paging message, turns on the second receiver when the first power-saving signal is detected, and the network device continues to send the second power-saving signal. FIG. 10 is a flowchart of a signal monitoring method according to an embodiment. The signal monitoring method, which is applied in the network device, can send the second power-saving signal using the steps as shown in FIG. 10.

In step S61, sending a second power-saving signal if sending one first power-saving signal.

In an embodiment of the present disclosure, the network device sends the second power-saving signal based on a first time interval after sending the first power-saving signal.

The terminal starts the first receiver to monitor the first power-saving signal, and determines a monitoring state for monitoring the first power-saving signal.

If the monitoring state is to start the second receiver to continue monitoring the second power-saving signal, the second receiver is started to monitor the second power-saving signal when the first power-saving signal is detected. The second receiver may be a main radio device. The power consumption of the first receiver is less than the power consumption of the second receiver. The second power-saving signal is configured to indicate whether the terminal monitors the PDCCH corresponding to the paging message and/or the PDSCH corresponding to the paging message. For example, the second power-saving signal is one bit, a bit of 1 indicates that the terminal monitors the PDCCH corresponding to the paging message and/or the PDSCH corresponding to the paging message, and a bit of 0 indicates that the terminal does not monitor the PDCCH corresponding to the paging message and/or the PDSCH corresponding to the paging message.

In embodiments of the present disclosure, there are a group of second power-saving signals, i.e., a plurality of second power-saving signals, and if the terminal detects the second power-saving signal at the corresponding transmission resource, it continues to start the second receiver to receive the paging message.

In embodiments of the present disclosure, the power consumption of the first receiver is less than the power consumption of the second receiver.

In the signal monitoring method provided in embodiments of the present disclosure, the power consumption of receivers of the terminal can be saved by first monitoring the first power-saving signal through the first receiver with almost zero power consumption. Starting the second receiver to monitor the second power-saving signal on a corresponding transmission resource in the case that the first power-saving signal is detected can reduce the waste of resources.

In some embodiments of the present disclosure, the second power-saving signal may be a group, i.e., the second power-saving signal includes a plurality of second power-saving signals. Each of the plurality of second power-saving signals corresponds to a terminal from a different group. FIG. 11 is a flowchart of a signal monitoring method according to an embodiment. The signal monitoring method, which is applied in a terminal, can send a plurality of second power-saving signals using the steps as shown in FIG. 11.

In step S71, sending second power-saving signals corresponding to transmission resources using different transmission resources.

In an embodiment of the present disclosure, the network device determines a group of second power-saving signals, i.e., a plurality of second power-saving signals, and sends the group of second power-saving signals based on the different transmission resources.

The terminal determines a second power-saving signal corresponding to the terminal among the plurality of second power-saving signals, and monitors the second power-saving signal in the corresponding transmission resource. If the second power-saving signal is detected, the terminal determines that there exists a subsequent signal related to the paging message, and continues to monitor the subsequent signal related to the paging message. As described above, the signal related to the paging message may be a PDSCH carrying the paging message and/or a PDCCH scheduling the paging message. If the terminal does not detect the corresponding second power-saving signal using the transmission resource, the monitoring of the paging message is skipped.

In embodiments of the present disclosure, whether there is a subsequent signal related to the monitored paging message is determined by the second power-saving signal, which can avoid power consumption caused by monitoring the paging message for a long period of time.

In some embodiments of the present disclosure, a time interval between sending the first power-saving signal and sending the second power-saving signal by the network device is greater than or equal to a first time threshold. The first time threshold is determined based on a communication protocol or a communication capability of the terminal. The time interval between the first power-saving signal and the second power-saving signal is greater than or equal to the first time threshold, which can avoid the terminal losing the paging message to be monitored.

In some embodiments of the present disclosure, the first power-saving signal may include a plurality of first power-saving signals, and each of the plurality of first power-saving signals corresponding to a terminal from a different group. The first power-saving signal is configured to indicate whether the terminal monitors a PDCCH corresponding to a paging message and/or a PDSCH corresponding to a paging message. FIG. 12 is a flowchart of a signal monitoring method according to an embodiment. The signal monitoring method, which is applied in a terminal, can send a first power-saving signal using the steps as shown in FIG. 12.

In step S81, sending first power-saving signals corresponding to transmission resources using different transmission resources.

The first power-saving signal is configured to indicate whether the terminal monitors the PDCCH corresponding to the paging message and/or the PDSCH corresponding to the paging message.

In embodiments of the present disclosure, the terminal determines a group of first power-saving signals, i.e., a plurality of first power-saving signals, and sends the first power-saving signals corresponding to the transmission resources using different transmission resources.

The terminal determines a first power-saving signal corresponding to the terminal among the plurality of first power-saving signals, and monitors the first power-saving signal in the corresponding transmission resource. If the first power-saving signal is detected, the terminal determines that there exists a subsequent signal related to the paging message, and continues to monitor the subsequent signal related to the paging message. As described above, the signal related to the paging message may be a PDSCH carrying the paging message and/or a PDCCH scheduling the paging message. If the terminal does not detect the corresponding first power-saving signal using the transmission resource, the monitoring of the paging message is skipped. The terminal monitors the first power-saving signal at the corresponding transmission resource, which can avoid wasting resources and power consumption caused by the terminal monitoring other first power-saving signals.

In some embodiments of the present disclosure, a time interval between the first power-saving signal and the signal related to the paging message is greater than or equal to a second time threshold. The second time threshold is determined based on a communication protocol or a communication capability of the terminal. It can be avoided that the terminal loses the signal related to the paging message due to switching receivers.

Based on the same idea, embodiments of the present disclosure also provide a signal monitoring device.

It is to be understood that the signal monitoring device provided in the embodiments of the present disclosure includes, in order to realize the above-described functions, a hardware structure and/or a software module corresponding to the execution of respective functions. In combination with the units and algorithmic steps of the various examples disclosed in the embodiments of the present disclosure, the embodiments of the present disclosure are capable of being realized in the form of hardware or a combination of hardware and computer software. Whether a particular function is performed as hardware or computer software driving hardware depends on the particular application and design constraints of the technical solution. Those skilled in the art may use a different approach for each particular application to implement the described functionality, but such implementations should not be considered outside the scope of the technical solutions of the embodiments of the present disclosure.

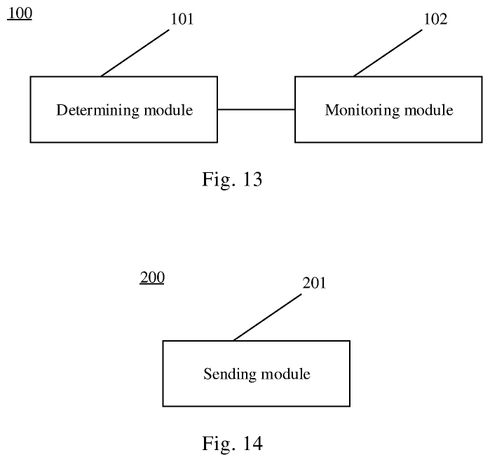

FIG. 13 is a block diagram of a signal monitoring device according to an embodiment. Referring to FIG. 13, the signal monitoring device 100, performed by a terminal, includes a determining module 101 and a monitoring module 102.

The determining module 101 is configured to start a first receiver to monitor a first power-saving signal, and determine a monitoring behavior of a paging message based on a monitoring state of the first power-saving signal. The monitoring module 102 is configured to start a second receiver to monitor a signal related to the paging message based on the monitoring state, based on the monitoring behavior.

In embodiments of the present disclosure, the signal related to the paging message includes: PDSCH carrying the paging message and/or PDCCH scheduling the paging message.

In embodiments of the present disclosure, the first power-saving signal includes one first power-saving signal.

Monitoring module 102 is configured to turning on a second receiver to monitor the second power-saving signal in response to the first receiver detecting the first power-saving signal. The second power-saving signal is configured to indicate whether the terminal monitors a PDCCH corresponding to a paging message and/or a PDSCH corresponding to a paging message.

In embodiments of the present disclosure, the second power-saving signal includes a plurality of second power-saving signals, and each of the plurality of second power-saving signals corresponds to a terminal from a different group.

The monitoring module 102 is configured to determine, among the plurality of second power-saving signals, a second power-saving signal corresponding to the terminal, and determine a transmission resource for carrying the second power-saving signal corresponding to the terminal. The second power-saving signal corresponding to the terminal is monitored using the transmission resource.

In embodiments of the present disclosure, a time interval between the first power-saving signal and the second power-saving signal is greater than or equal to a first time threshold.

In embodiments of the present disclosure, the first time threshold is determined based on a communication protocol or a communication capability of the terminal.

In embodiments of the present disclosure, the first power-saving signal includes a plurality of first power-saving signals, and each of the plurality of first power-saving signals corresponds to a terminal from a different group. The first power-saving signals are configured to instruct the terminal to monitor a PDCCH corresponding to a paging message and/or a PDSCH corresponding to a paging message.

The monitoring module 102 is configured to determine, among the plurality of first power-saving signals, a first power-saving signal corresponding to the terminal, and determine a transmission resource for carrying the first power-saving signal corresponding to the terminal. The first power-saving signal corresponding to the terminal is monitored using the transmission resource.

In embodiments of the present disclosure, a time interval between the first power-saving signal and the signal related to the paging message is greater than or equal to a second time threshold.

In embodiments of the present disclosure, the second time threshold is determined based on a communication protocol or a communication capability of the terminal.

FIG. 14 is a block diagram of a signal monitoring device according to an embodiment. Referring to FIG. 14, the signal monitoring device 200, performed by a network device, includes a sending module 201.

The sending module 201 is configured to send a first power-saving signal which is monitored by a terminal starting a first receiver. The first power-saving signal is configured for the terminal to determine a monitoring behavior for a paging message, and the monitoring behavior is configured for the terminal to perform monitoring of a signal related to the paging message.

In embodiments of the present disclosure, the signal related to the paging message includes: PDSCH for carrying the paging message and/or PDCCH for scheduling the paging message.

In the embodiments of the present disclosure, the sending module 201 is further configured to send a second power-saving signal if sending one first power-saving signal.

In this embodiment of the present disclosure, there are a plurality of the second power-saving signals, and each of the plurality of second power-saving signals corresponds to a terminal from a different group.

The sending module 201 is configured to send the second power-saving signal corresponding to the transmission resource in the different transmission resources. The second power-saving signal is configured to indicate whether the terminal monitors the PDCCH corresponding to the paging message and/or the PDSCH corresponding to the paging message.

In embodiments of the present disclosure, a time interval between the first power-saving signal and the second power-saving signal is greater than or equal to a first time threshold.

In embodiments of the present disclosure, the first time threshold is determined based on a communication protocol or a communication capability of the terminal.

In embodiments of the present disclosure, the first power-saving signal includes a plurality of first power-saving signals, and each of the plurality of the first power-saving signals corresponds to a terminal from a different group.

The sending module 201 is configured to send the first power-saving signals corresponding to the transmission resources in the different transmission resources. The first power-saving signals are configured to indicate whether the terminal monitors the PDCCH corresponding to the paging message and/or the PDSCH corresponding to the paging message.

In embodiments of the present disclosure, a time interval between the first power-saving signal and the signal related to the paging message is greater than or equal to a second time threshold.

In embodiments of the present disclosure, the second time threshold is determined based on a communication protocol or a communication capability of the terminal.

With respect to the device in the above embodiment, the specific manner in which each module performs an operation has been described in detail in the embodiments relating to the method, and will not be described in detail herein.

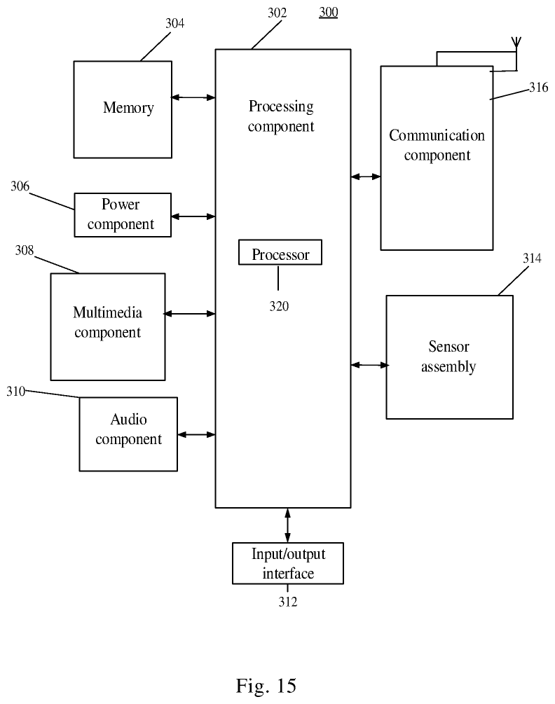

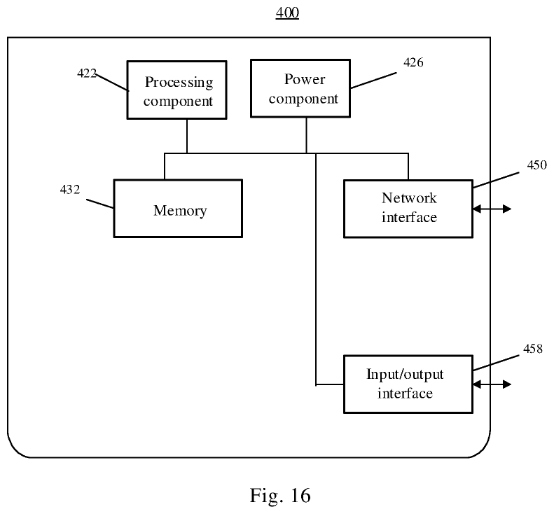

FIG. 15 is a block diagram of a device 300 for signal monitoring according to an embodiment. For example, the device 300 may be a cell phone, a computer, a digital broadcast terminal, a message transceiver device, a game console, a tablet device, a medical device, a fitness device, a personal digital assistant, and the like.

Referring to FIG. 15, the device 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the device 300, such as operations associated with display, telephone calling, data communication, camera operation, and recording operation. The processing component 302 may include one or more processors 320 to execute instructions to accomplish all or some of the steps of the method described above. In addition, the processing component 302 may include one or more modules to facilitate interaction between the processing component 302 and other components. For example, the processing component 302 may include a multimedia module to facilitate interaction between the multimedia component 308 and the processing component 302.

The memory 304 is configured to store various types of data to support operation at the device 300. Examples of such data include instructions for any application or method operated on the device 300, contact data, phone book data, messages, pictures, videos, etc. The memory 304 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, a disk or optical disk.

The power component 306 provides power to the various components of the device 300. The power component 306 may include a power management system, one or more power sources, and other components associated with generating, managing, and distributing power for the device 300.

The multimedia component 308 includes a screen providing an output interface between the device 300 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to monitor touches, swipes, and gestures on the touch panel. The touch sensors may not only sense the boundaries of the touch or swipe action, but also detect the duration and pressure associated with the touch or swipe operation. In some embodiments, the multimedia component 308 includes a front camera and/or a rear camera. The front camera and/or the rear camera may receive external multimedia data when the device 300 is in an operational mode, such as a shooting mode or a video mode. Each of the front camera and the rear camera may be a fixed optical lens system or have a focal length and optical zoom capability.

The audio component 310 is configured to output and/or input audio signals. For example, the audio component 310 includes a microphone (MIC) that is configured to receive external audio signals when the device 300 is in an operational mode, such as a call mode, a recording mode, and a voice recognition mode. The received audio signals may be further stored in the memory 304 or sent via the communication component 316. In some embodiments, the audio component 310 further includes a speaker for outputting audio signals.

The I/O interface 312 provides an interface between the processing component 302 and a peripheral interface module. The peripheral interface module may be a keypad, click wheel, buttons, etc. These buttons may include, but are not limited to: a home button, a volume button, a start button, and a lock button.

The sensor assembly 314 includes one or more sensors for providing state assessment of various aspects of the device 300. For example, the sensor assembly 314 may detect an open/closed state of the device 300, the relative positioning of components. For example, the components are the display and keypad of the device 300. The sensor assembly 314 may also detect a change in the position of the device 300 or a component of the device 300, the presence or absence of user contact with the device 300, an orientation of the device 300 or an acceleration/deceleration of the device 300, and temperature change of the device 300. The sensor assembly 314 may include a proximity sensor configured to detect the presence of a nearby object in the absence of any physical contact. The sensor assembly 314 may also include an optical sensor, such as a CMOS or CCD image sensor, for use in imaging applications. In some embodiments, the sensor assembly 314 may also include an acceleration sensor, a gyroscope sensor, a magnetic sensor, a pressure sensor, or a temperature sensor.

The communication component 316 is configured to facilitate communication between the device 300 and other devices by wired or wireless means. The device 300 may have access to a wireless network based on a communication standard, such as Wi-Fi, 2G or 3G, or a combination thereof. In an embodiment, the communication component 316 receives broadcast signals or broadcast-related information from an external broadcast management system via a broadcast channel. In an embodiment, the communication component 316 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In some embodiments, the device 300 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the methods described above.

In some embodiments, there is also provided a non-transitory computer-readable storage medium including instructions, such as a memory 304 including instructions. The instructions are executable by a processor 320 of the device 300 for accomplishing the method. The non-transitory computer-readable storage medium may be, for example, ROM, random access memory (RAM), CD-ROM, magnetic tape, floppy disks, and optical data storage devices.

FIG. 16 is a block diagram of a device 400 for signal monitoring according to an embodiment. For example, the device 400 may be provided as a server. Referring to FIG. 16, the device 400 includes a processing component 422, which further includes one or more processors, and memory resources represented by a memory 432 for storing instructions, such as an application program, that may be executed by the processing component 422. The application program stored in memory 432 may include one or more modules each corresponding to a set of instructions. In addition, the processing component 422 is configured to execute the instructions to perform the method described above.

The device 400 may further include a power component 426 configured to perform power management of the device 400, a wired or wireless network interface 450 configured to connect the device 400 to a network, and an input/output (I/O) interface 458. The device 400 may operate an operating system stored in the memory 432, such as Windows Server™, a Mac OS X™, Unix™, Linux™, FreeBSD™ or the like.

According to a first aspect of the present disclosure, there is provided a signal monitoring method, performed by a terminal, including: monitoring a first power-saving signal by starting a first receiver, and determining a monitoring behavior of a paging message based on a monitoring state of the first power-saving signal; and monitoring, based on the monitoring behavior, a signal related to the paging message by starting a second receiver.

In an embodiment, the signal related to the paging message includes a PDSCH carrying the paging message and/or a PDCCH scheduling the paging message.

In an embodiment, the first power-saving signal includes one first power-saving signal. Monitoring, based on the monitoring behavior, the signal related to the paging message by starting a second receiver includes monitoring, based on the monitoring behavior, a second power-saving signal by starting the second receiver; the second power-saving signal is configured to indicate whether the terminal monitors the PDCCH corresponding to the paging message and/or the PDSCH corresponding to the paging message.

In an embodiment, the second power-saving signal includes a plurality of second power-saving signals, and each of the plurality of second power-saving signals corresponds to a terminal from a different group. Monitoring the second power-saving signal by starting the second receiver includes determining, among the plurality of second power-saving signals, a second power-saving signal corresponding to the terminal, and determining a transmission resource for carrying the second power-saving signal corresponding to the terminal; and monitoring, using the transmission resource, the second power-saving signal corresponding to the terminal.

In an embodiment, a time interval between the first power-saving signal and the second power-saving signal is greater than or equal to a first time threshold.

In an embodiment, the first time threshold is determined based on a communication protocol or a communication capability of the terminal.

In an embodiment, the first power-saving signal includes a plurality of first power-saving signals, and each of the plurality of first power-saving signals corresponds to a terminal from a different group. The first power-saving signals are configured to instruct the terminal to monitor the PDCCH corresponding to the paging message and/or the PDSCH corresponding to the paging message. Monitoring the first power-saving signal by starting the first receiver includes determining, among the plurality of first power-saving signals, a first power-saving signal corresponding to the terminal, and determining a transmission resource for carrying the first power-saving signal corresponding to the terminal; and monitoring, using the transmission resource, the first power-saving signal corresponding to the terminal.

In an embodiment, a time interval between the first power-saving signal and the signal related to the paging message is greater than or equal to a second time threshold.

In an embodiment, the second time threshold is determined based on a communication protocol or a communication capability of the terminal.

According to a second aspect of the present disclosure, there is provided a signal monitoring method, performed by a network device, including sending a first power-saving signal which is monitored by a terminal starting a first receiver, where the first power-saving signal is configured for the terminal to determine a monitoring behavior of a paging message, and the monitoring behavior is configured for the terminal to perform monitoring of a signal related to the paging message.

In an embodiment, the signal related to the paging message includes a PDSCH carrying the paging message and/or a PDCCH scheduling the paging message.

In an embodiment, after sending the first power-saving signal which is monitored by the terminal starting the first receiver, the method further includes sending a second power-saving signal if sending one first power-saving signal.

In an embodiment, the second power-saving signal is a plurality of second power-saving signals, and each of the plurality of second power-saving signals corresponds to a terminal from a different group. Sending the second power-saving signal includes sending, using different transmission resources, second power-saving signals corresponding to the transmission resources. The second power-saving signals are configured to indicate whether the terminal monitors a PDCCH corresponding to the paging message and/or a PDSCH corresponding to the paging message.

In an embodiment, a time interval between the first power-saving signal and the second power-saving signal is greater than or equal to a first time threshold.

In an embodiment, the first time threshold is determined based on a communication protocol or a communication capability of the terminal.

In an embodiment, the first power-saving signal includes a plurality of first power-saving signals, and each of the plurality of first power-saving signals corresponds to a terminal from a different group. Sending the first power-saving signal which is monitored by the terminal starting the first receiver includes sending, using different transmission resources, first power-saving signals corresponding to the transmission resources; the first power-saving signals are configured to indicate whether the terminal monitors a PDCCH corresponding to a paging message and/or a PDSCH corresponding to a paging message.

In an embodiment, a time interval between the first power-saving signal and the signal related to the paging message is greater than or equal to a second time threshold.

In an embodiment, the second time threshold is determined based on a communication protocol or a communication capability of the terminal.

According to a third aspect of the present disclosure, there is provided a signal monitoring device, performed by the terminal, including a determining module configured to monitor a first power-saving signal by starting a first receiver, and determine a monitoring behavior of a paging message based on a monitoring state of the first power-saving signal; and a monitoring module configured to monitor, based on the monitoring behavior, a signal related to the paging message by starting a second receiver.

In an embodiment, the signal related to the paging message includes a PDSCH carrying the paging message and/or a PDCCH scheduling the paging message.

In an embodiment, the first power-saving signal includes one first power-saving signal. The monitoring module is configured to monitor, based on the monitoring behavior, a second power-saving signal by starting the second receiver; the second power-saving signal is configured to indicate whether the terminal monitors the PDCCH corresponding to the paging message and/or the PDSCH corresponding to the paging message.

In an embodiment, the second power-saving signal includes a plurality of second power-saving signals, and each of the plurality of second power-saving signals corresponds to a terminal from a different group. The monitoring module is configured to determine, among the plurality of second power-saving signals, a second power-saving signal corresponding to the terminal, and determine a transmission resource for carrying the second power-saving signal corresponding to the terminal; and monitor, using the transmission resource, the second power-saving signal corresponding to the terminal.

In an embodiment, a time interval between the first power-saving signal and the second power-saving signal is greater than or equal to a first time threshold.

In an embodiment, the first time threshold is determined based on a communication protocol or a communication capability of the terminal.

In an embodiment, the first power-saving signal includes a plurality of first power-saving signals, and each of the plurality of first power-saving signals corresponds to a terminal from a different group. The first power-saving signals are configured to instruct the terminal to monitor the PDCCH corresponding to the paging message and/or the PDSCH corresponding to the paging message. The monitoring module is configured to determine, among the plurality of first power-saving signals, a first power-saving signal corresponding to the terminal, and determine a transmission resource for carrying the first power-saving signal corresponding to the terminal; and monitor, using the transmission resource, the first power-saving signal corresponding to the terminal.

In an embodiment, a time interval between the first power-saving signal and the signal related to the paging message is greater than or equal to a second time threshold.

In an embodiment, the second time threshold is determined based on a communication protocol or a communication capability of the terminal.

According to a fourth aspect of the present disclosure, there is provided a signal monitoring device, performed by a network device, including a sending module configured to send a first power-saving signal which is monitored by a terminal starting a first receiver, where the first power-saving signal is configured for the terminal to determine a monitoring behavior of a paging message, and the monitoring behavior is configured for the terminal to perform monitoring of a signal related to the paging message.

In an embodiment, the signal related to the paging message includes a PDSCH carrying the paging message and/or a PDCCH scheduling the paging message.

In an embodiment, the sending module is further configured to send a second power-saving signal if sending one first power-saving signal.

In an embodiment, the second power-saving signal is a plurality of second power-saving signals, and each of the plurality of second power-saving signals corresponds to a terminal from a different group. The sending module is configured to send, using different transmission resources, second power-saving signals corresponding to the transmission resources. The second power-saving signals are configured to indicate whether the terminal monitors a PDCCH corresponding to the paging message and/or a PDSCH corresponding to the paging message.

In an embodiment, a time interval between the first power-saving signal and the second power-saving signal is greater than or equal to a first time threshold.

In an embodiment, the first time threshold is determined based on a communication protocol or a communication capability of the terminal.

In an embodiment, the first power-saving signal includes a plurality of first power-saving signals, and each of the plurality of first power-saving signals corresponds to a terminal from a different group. The sending module is configured to send, using different transmission resources, first power-saving signals corresponding to the transmission resources: the first power-saving signals are configured to indicate whether the terminal monitors a PDCCH corresponding to a paging message and/or a PDSCH corresponding to a paging message.

In an embodiment, a time interval between the first power-saving signal and the signal related to the paging message is greater than or equal to a second time threshold.

In an embodiment, the second time threshold is determined based on a communication protocol or a communication capability of the terminal.

According to a fifth aspect of the present disclosure, there is provided a signal monitoring device, including a processor; and a memory for storing processor executable instructions; where the processor is configured to perform the signal monitoring method according to the first aspect or any embodiment in the first aspect, or perform the signal monitoring method according to the second aspect or any embodiment in the second aspect.

According to a sixth aspect of the present disclosure, there is provided a non-transitory computer-readable storage medium that, when instructions in the storage medium are executed by a processor of a mobile terminal, starts the mobile terminal to perform the signal monitoring method according to the first aspect or any embodiment in the first aspect, or perform the signal monitoring method according to the second aspect or any embodiment in the second aspect.

It is further understood that “a plurality of” in this disclosure means two or more, and other quantifiers are similar. The character “and/or” describes an association relationship of an associated object, indicating that three relationships can exist, e.g., A and/or B, which can mean: A alone, both A and B, and B alone. The character “/” generally indicates an “or” relationship between the related objects. The singular forms “a”, “an” and “the” are also intended to include the majority form, unless the context clearly indicates otherwise.

It is further understood that the terms “first”, “second”, etc. are used to describe various types of information, but such information should not be limited to these terms. These terms are used only to distinguish the same type of information from one another and do not indicate a particular order or level of importance. Indeed, the expressions “first”, “second”, etc. may be used completely interchangeably. For example, without departing from the scope of the present disclosure, the first information may also be referred to as the second information, and similarly, the second information may also be referred to as the first information.

It is further to be understood that embodiments of the present disclosure, while describing operations in a particular order in the accompanying drawings, should not be construed as requiring that the operations be performed in the particular order shown or in a serial order, or requiring that all of the operations shown be performed in order to obtain a desired result. Multitasking and parallel processing may be advantageous in particular environments.

Other embodiments of the present disclosure will readily come to mind to those skilled in the art upon consideration of the specification and practice of the disclosure herein. The present application is intended to cover any variations, uses, or adaptations of the present disclosure that follow the general principles of the present disclosure and include common knowledge or customary technical means in the art not disclosed herein. The specification and embodiments are to be regarded as exemplary only, and the true scope and spirit of the present disclosure is indicated by the following scope of the claims.

It should be understood that the present disclosure is not limited to the precise structure which has been described above and illustrated in the accompanying drawings, and that various modifications and alterations may be made without departing from its scope. The scope of the present disclosure is limited only by the scope of the appended claims.

1. A signal monitoring method, performed by a terminal, comprising:
monitoring a first power-saving signal by starting a first receiver, and determining a monitoring behavior of a paging message based on a monitoring state of the first power-saving signal; and
monitoring, based on the monitoring behavior, a signal related to the paging message by starting a second receiver.

2. The signal monitoring method according to claim 1, wherein the signal related to the paging message comprises at least one of:
a Physical Downlink Shared Channel (PDSCH) carrying the paging message or a Physical Downlink Control Channel (PDCCH) scheduling the paging message.

3. The signal monitoring method according to claim 2, wherein the first power-saving signal comprises one first power-saving signal; and
monitoring, based on the monitoring behavior, the signal related to the paging message by starting a second receiver, comprises:
monitoring, based on the monitoring behavior, a second power-saving signal by starting the second receiver;
wherein the second power-saving signal is configured to indicate whether the terminal monitors at least one of the PDCCH corresponding to the paging message or the PDSCH corresponding to the paging message.

4. The signal monitoring method according to claim 3, wherein the second power-saving signal comprises a plurality of second power-saving signals, and each of the plurality of second power-saving signals corresponds to a terminal from a different group; and
monitoring the second power-saving signal by starting the second receiver, comprises:
determining, among the plurality of second power-saving signals, a second power-saving signal corresponding to the terminal, and determining a transmission resource for carrying the second power-saving signal corresponding to the terminal; and
monitoring, using the transmission resource, the second power-saving signal corresponding to the terminal.

5. The signal monitoring method according to claim 3, wherein a time interval between the first power-saving signal and the second power-saving signal is greater than or equal to a first time threshold.

6. The signal monitoring method according to claim 5, wherein the first time threshold is determined based on a communication protocol or a communication capability of the terminal.

7. The signal monitoring method according to claim 2, wherein the first power-saving signal comprises a plurality of first power-saving signals, each of the plurality of first power-saving signals corresponds to a terminal from a different group, and the first power-saving signals are configured to instruct the terminal to monitor at least one of the PDCCH corresponding to the paging message or the PDSCH corresponding to the paging message; and
monitoring the first power-saving signal by starting the first receiver, comprises:
determining, among the plurality of first power-saving signals, a first power-saving signal corresponding to the terminal, and determining a transmission resource for carrying the first power-saving signal corresponding to the terminal; and
monitoring, using the transmission resource, the first power-saving signal corresponding to the terminal.

8. The signal monitoring method according to claim 7, wherein a time interval between the first power-saving signal and the signal related to the paging message is greater than or equal to a second time threshold.

9. The signal monitoring method according to claim 8, wherein the second time threshold is determined based on a communication protocol or a communication capability of the terminal.

10. A signal monitoring method, performed by a network device, comprising:
sending a first power-saving signal which is monitored by a terminal starting a first receiver, wherein the first power-saving signal is configured for the terminal to determine a monitoring behavior of a paging message, and the monitoring behavior is configured for the terminal to perform monitoring of a signal related to the paging message.

11. The signal monitoring method according to claim 10, wherein the signal related to the paging message comprises at least one of:
a Physical Downlink Shared Channel (PDSCH) carrying the paging message or a Physical Downlink Control Channel (PDCCH) scheduling the paging message.

12. The signal monitoring method according to claim 10, comprising:
sending a second power-saving signal in response to sending one first power-saving signal.

13. The signal monitoring method according to claim 12, wherein the second power-saving signal comprises a plurality of second power-saving signals, and each of the plurality of second power-saving signals corresponds to a terminal from a different group; and
sending the second power-saving signal, comprises:
sending, using a different transmission resource, each of the second power-saving signals corresponding to the transmission resource;
wherein the second power-saving signal is configured to indicate whether the terminal monitors at least one of a PDCCH corresponding to the paging message or a PDSCH corresponding to the paging message.

14. The signal monitoring method according to claim 12, wherein a time interval between the first power-saving signal and the second power-saving signal is greater than or equal to a first time threshold.

15. The signal monitoring method according to claim 14, wherein the first time threshold is determined based on a communication protocol or a communication capability of the terminal.

16. The signal monitoring method according to claim 10, wherein the first power-saving signal comprises a plurality of first power-saving signals, and each of the plurality of first power-saving signals corresponds to a terminal from a different group; and
sending the first power-saving signal which is monitored by the terminal starting the first receiver, comprises:
sending, using a different transmission resources resource, each of the first power-saving signals corresponding to the transmission resource;
wherein the first power-saving signal is configured to indicate whether the terminal monitors at least one of a PDCCH corresponding to a paging message or a PDSCH corresponding to a paging message.

17. The signal monitoring method according to claim 16, wherein a time interval between the first power-saving signal and the signal related to the paging message is greater than or equal to a second time threshold.

18. The signal monitoring method according to claim 17, wherein the second time threshold is determined based on a communication protocol or a communication capability of the terminal.

19. (canceled)

20. (canceled)

21. A signal monitoring device, comprising:
a processor; and
a memory for storing processor executable instructions;
wherein the processor is configured to:
monitor a first power-saving signal by starting a first receiver, and determine a monitoring behavior of a paging message based on a monitoring state of the first power-saving signal; and
monitor, based on the monitoring behavior, a signal related to the paging message by starting a second receiver.

22. (canceled)

23. A signal monitoring device, comprising:
a processor; and
a memory for storing processor executable instructions;
wherein the processor is configured to perform the method according to claim 10.
